(19) United States
(12) Patent Application Publication
(10) Pub. No.: US 2020/0089740 A1
(43) Pub. Date: Mar. 19, 2020

(54) STRUCTURAL PATENT-CLAIM-GRAPHIC AUTOMATIC DISPLAYING EQUIPMENT

(71) Applicant: INTEGRAL SEARCH INTERNATIONAL LIMITED, Taipei (TW)

(72) Inventor: Hong-Shin TSAI, Taipei (TW)

(73) Assignee: INTEGRAL SEARCH INTERNATIONAL LIMITED, Taipei (TW)

(21) Appl. No.: 16/575,159

(22) Filed: Sep. 18, 2019

(30) Foreign Application Priority Data
Sep. 19, 2018 (TW) 107133059

(51) Int. Cl. G06F 17/22; G06T 11/60; G06K 9/00; G06Q 50/18

(52) U.S. Cl. CPC G06F 17/227; G06Q 50/184; G06K 9/00469; G06T 11/60

(57) ABSTRACT

A structural patent-claim-graphic automatic displaying equipment, including a paragraph-content-and-paragraph-hierarchical-level-value determining device, an element noun data obtaining device, an interrelationship data obtaining device, and a division content obtaining device, automatically transfers a patent claim to a structural patent-claim-graphic automatic displaying equipment and displays the structural patent-claim-graphic automatic displaying equipment.

### FIELD OF THE INVENTION

The present invention relates to a patent-document-graphic automatic displaying equipment, and more particularly relates to a structural patent-claim-graphic automatic displaying equipment.

### BACKGROUND OF THE INVENTION

For patent document reading, it requires expertise and experience, and consumes considerable manpower and time as well, since the structure of a claim is usually complicated. The structure includes a subject element noun, an object element noun and interrelationship data that defines the interrelationship between the subject element noun and the object element noun. The complicated structure comes with the increased amount of interrelationships together with the increased amount of the subject element nouns and the object element nouns. A patent document reader is inevitable to read a claim through a repeated cross-reference among element nouns and a plurality of interrelationships to comprehend the meaning of the patent document. Especially for patent analysis or infringement analysis, which requires more precise reading for analysis, the patent document reading becomes more time-consuming and has to take more effort to obtain a professional reading result.

Therefore, it is an issue about how to illustrate the content of a claim in an easier way. Especially, it is an issue about how to obtain a visual graphic for illustrating the content of a claim to reduce the claim reading time and improve correctness and comfort for claim reading. Further, it is an issue about how to display a structural patent-claim-graphic claim in a machine-automatic-generating way.

### SUMMARY OF THE INVENTION

Therefore, an objective of the present invention is to provide a structural patent-claim-graphic automatic displaying equipment that utilizes an automatic equipment to automatically generate the structural patent-claim graphic corresponding to a claim and display the structural patent-claim graphic. The visualization claim displaying is with advantage to reduce the patent reading time, enhance the reading correctness and comfort, and simplify the correctness check of the claim structure for the third party.

In order to solve the abovementioned problem, the present invention provides a structural patent-claim-graphic automatic displaying equipment that automatically transfers a patent claim to a structural patent-claim-graphic and displays the structural patent-claim-graphic, the structural patent-claim-graphic automatic displaying equipment comprising: a paragraph-content-and-paragraph-hierarchical-level-value determining device, which determines, for all paragraphs in the patent claim, a paragraph content and a paragraph hierarchical level value corresponding to the paragraph; an element noun data obtaining device being connected to the paragraph-content-and-paragraph-hierarchical-level-value determining device, the element noun data obtaining device obtaining all element noun data from each paragraph content according to a part-of-speech of paragraph content words and a word separating rule; an interrelationship data obtaining device being connected to the paragraph-content-and-paragraph-hierarchical-level-value determining device and the element noun data obtaining device, the interrelationship data obtaining device obtaining, from each paragraph content, interrelationship data which corresponds to the obtained element noun data; a division content obtaining device being connected to the paragraph-content-and-paragraph-hierarchical-level-value determining device, the element noun data obtaining device and the interrelationship data obtaining device, wherein the division content obtaining device divides each paragraph content to one or more division contents, each division content includes a division data content and a division data hierarchical level value corresponding to the division data content, and the division data content is a combination of the element noun data and/or the interrelationship data; and a structural patent-claim-graphic displaying device being connected to the paragraph-content-and-paragraph-hierarchical-level-value determining device and the division content obtaining device, wherein the structural patent-claim-graphic displaying device displays the structural patent-claim-graphic including the obtained element noun data, an element noun hierarchic relationship of the obtained element noun data, the obtained interrelationship data and a relationship between/among the obtained element noun data and the obtained interrelationship data, in such a manner that the structural patent-claim-graphic is displayed according to, in each paragraph, the paragraph hierarchical level value, a sequential order of the plurality of the division contents, the division data content and the division data content hierarchical level value, and the structural patent-claim-graphic has a hierarchical structure and hierarchical position relationship.

In one embodiment of the present invention, the structural patent-claim-graphic automatic displaying equipment is provided that the structural patent-claim-graphic is displayed by determining whether the division data content is a subordinating interrelationship word and/or is a punctuation mark.

In one embodiment of the present invention, the structural patent-claim-graphic automatic displaying equipment is provided that the structural patent-claim-graphic is displayed by determining a subordinating relationship between/among the plurality of element noun data of the division data content.

In one embodiment of the present invention, the structural patent-claim-graphic automatic displaying equipment is provided that the element noun data is displayed at a node and the interrelationship data is displayed as a connecting line connected between a plurality of the nodes.

In one embodiment of the present invention, the structural patent-claim-graphic automatic displaying equipment is provided that the division content obtaining device enables one or more of the obtained division contents to be recorded in a log file and the log file is transferred to the structural patent-claim-graphic displaying device such that the structural patent-claim-graphic displaying device displays the structural patent-claim-graphic according to the log file.

In one embodiment of the present invention, the structural patent-claim-graphic automatic displaying equipment is provided that the log file is recorded according to a positional sequence of the element noun data and the interrelationship data in each paragraph.

In one embodiment of the present invention, the structural patent-claim-graphic automatic displaying equipment further comprises a connection line color determining device, the connection line color determining device being provided to determine a color of a connection line of each paragraph according to coherent characteristics and adjacent characteristics of the interrelationship data in each paragraph, in which the connecting line being provided to represent the interrelationship data.

In one embodiment of the present invention, the structural patent-claim-graphic automatic displaying equipment further comprises a connection line direction determining device, the connection line direction determining device determining a direction of the connection line according to a relationship among the interrelationship data and the two element noun data to which the connection line is connected.

In one embodiment of the present invention, the structural patent-claim-graphic automatic displaying equipment further comprises a hierarchical level input device, the hierarchical level input device being connected to the structural patent-claim-graphic displaying device, the hierarchical level input device having a hierarchical level input interface, the hierarchical level input interface being provided, after a user inputs a hierarchical level number, to designate a hierarchical range of the structural patent-claim-graphic displayed by the structural patent-claim-graphic displaying device.

In one embodiment of the present invention, the structural patent-claim-graphic automatic displaying equipment further comprises a division data content determining device, the division data content determining device being connected to the structural patent-claim-graphic displaying device, the division data content determining device having a division data content determining interface which allows a user to designate a designated element noun data and/or a designated interrelationship of the structural patent-claim-graphic so as to display all of route data connected between/among the designated element noun data and/or the designated interrelationship data, wherein the route data includes the element noun data and/or the interrelationship data which are/is connected to the designated element noun data and/or the designated interrelationship data.

The structural patent-claim-graphic automatic displaying equipment of the present invention is with the following effects.

The present invention is to provide a structural patent-claim-graphic automatic displaying equipment that utilizes the automatic equipment to automatically generate the structural patent-claim-graphic corresponding to a claim and display the structural patent-claim graphic. The visualization claim displaying is with advantage to reduce the patent reading time, enhance the reading correctness and comfort, and simplify the correctness check of the claim structure for the third party.

### BRIEF DESCRIPTION OF THE DRAWINGS

FIG. 1 is a structure block diagram illustrating a structural patent-claim-graphic automatic displaying equipment according to one embodiment of the present invention;

FIG. 2 is a comparison diagram between an original claim and a claim processed by the structural patent-claim-graphic automatic displaying equipment according to the embodiment of the present invention;

FIG. 3 is a schematic diagram illustrating a plurality of paragraphs and paragraph contents in a claim displayed by the structural patent-claim-graphic automatic displaying equipment according to the embodiment of the present invention;

FIG. 4 is a structure block diagram illustrating an element noun data obtaining device of the structural patent-claim-graphic automatic displaying equipment according to the embodiment of the present invention;

FIG. 5 is a schematic diagram illustrating a separating rule table of the structural patent-claim-graphic automatic displaying equipment according to the embodiment of the present invention;

FIG. 6 is a schematic diagram illustrating paragraphs of the structural patent-claim-graphic automatic displaying equipment according to the embodiment of the present invention;

FIG. 7 is a schematic diagram illustrating a structural patent-claim-graphic of the structural patent-claim-graphic automatic displaying equipment according to the embodiment of the present invention;

FIG. 8 is a schematic diagram illustrating a structural patent-claim-graphic of the structural patent-claim-graphic automatic displaying equipment according to the embodiment of the present invention;

FIG. 9 is a schematic diagram illustrating a structural patent-claim-graphic of the structural patent-claim-graphic automatic displaying equipment according to the embodiment of the present invention; and

FIG. 10 is a schematic diagram illustrating a structural patent-claim-graphic of the structural patent-claim-graphic automatic displaying equipment according to the embodiment of the present invention.

### DETAILED DESCRIPTION OF THE PREFERRED EMBODIMENTS

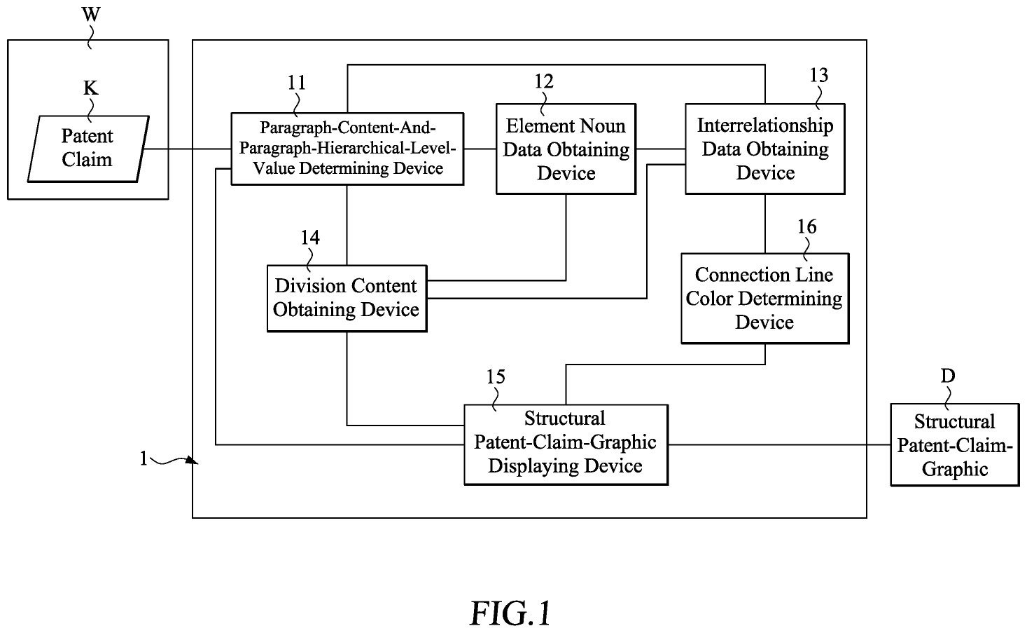

The preferred embodiments of the present invention are described in detail below with reference to FIG. 1 to FIG. 10. The description is used for explaining the embodiments of the present invention only, but not for limiting the scope of the claims.

As shown in FIG. 1, according to one embodiment of the present invention, a structural patent-claim-graphic automatic displaying equipment 1 automatically transfers a patent claim K of a patent document W to a structural patent-claim-graphic D and displays the structural patent-claim-graphic D.

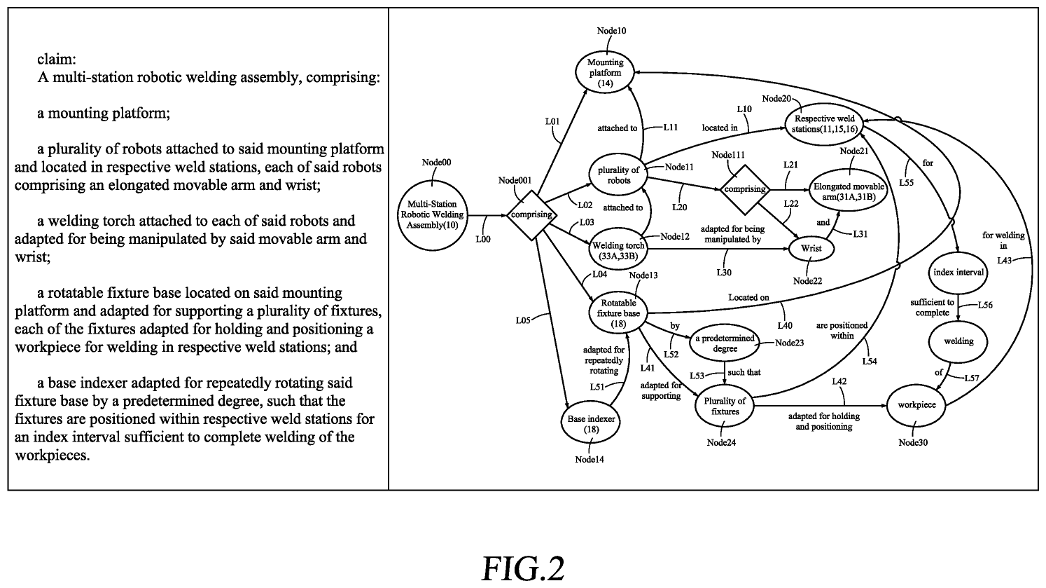

A comparison between the original patent claim K and the structural patent-claim-graphic D generated by the structural patent-claim-graphic automatic displaying equipment 1 of the present invention is shown in FIG. 2.

As shown in FIG. 1, the structural patent-claim-graphic automatic displaying equipment 1 includes: a paragraph-content-and-paragraph-hierarchical-level-value determining device 11, an element noun data obtaining device 12, an interrelationship data obtaining device 13, a division content obtaining device 14, and a structural patent-claim-graphic displaying device 15.

All devices of the structural patent-claim-graphic automatic displaying equipment 1 of the present invention are explained below with reference to the accompanying drawings.

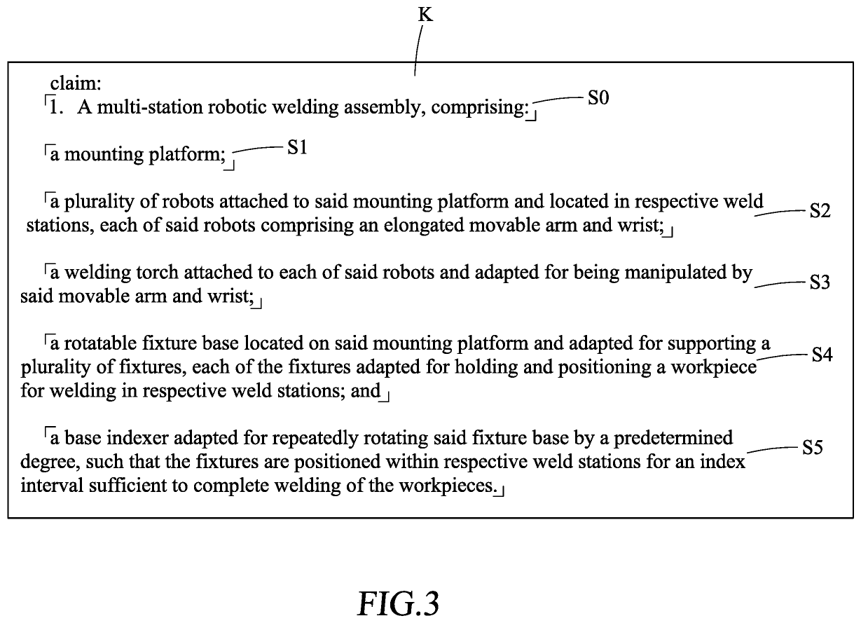

The structural patent-claim-graphic automatic displaying equipment 1 reads a patent claim HTML-text document to obtain an original patent claim. In other words, the original claim to be read by the present application is in a HTML-text format. As shown in FIG. 1 and FIG. 3, the paragraph-content-and-paragraph-hierarchical-level-value determining device 11 determines a paragraph content C and a paragraph hierarchical level value L for each paragraph S of the patent claim K of a patent document W such that each paragraph content C is with the corresponding paragraph hierarchical level value L.

As shown in FIG. 3, a plurality of paragraphs S are provided in a claim K, wherein each paragraph S includes the paragraph content C and a corresponding paragraph hierarchical level value L to which the paragraph content C belongs. For example, a preamble (paragraph S0), which is a top portion of the claim, has a paragraph content C0 of “A multi-station robotic welding assembly, comprising:”, and has the paragraph hierarchical level value L0 of 0 since “A multi-station robotic welding assembly, comprising:” is a preamble. With regard to the paragraph S1, a paragraph content C1, which is with content of “a mounting platform;”. In the patent claim HTML-text, the paragraph S0 and paragraph S1 have been hierarchically displayed in such a manner that the paragraph S1 is configured to be the next hierarchical level of the paragraph S0. Therefore, the paragraph hierarchical level value L1 of the paragraph content C1 is determined as 1. In detail, in a file of HTML format of the patent claim HTML-text, all paragraphs are separated by “<div>” and “</div>”. The following example shows three paragraphs being separated by “<div>” and “</div>”.

<div> A multi-station robotic welding assembly, comprising:

<div> a mounting platform; </div>

<div> a plurality of robots attached to said mounting platform and located in respective weld stations, each of said robots comprising an elongated movable arm and wrist. </div></div>”

In the present invention, “<div>” and “</div>” are applied to divide the first paragraph S0, the second paragraph S1, and the third paragraph S2 to respective hierarchical levels. The present invention, by the use of “<div>” and “</div>”, determines the paragraph hierarchical level value L of each paragraph content C. Accordingly, the paragraph hierarchical level value L1 of the paragraph content C1 is determined as 1. The paragraph S2, whose paragraph content C2 is “a plurality of robots attached to said mounting platform and located in respective weld stations, each of said robots comprising an elongated movable arm and wrist;” is with the paragraph hierarchical level value L2 of 1 since “</div>” is appeared at the end of the paragraph S1. That is to say, the paragraph hierarchical level value L of each paragraph content C is determined according to the appearing position of “<div>” and “</div>”.

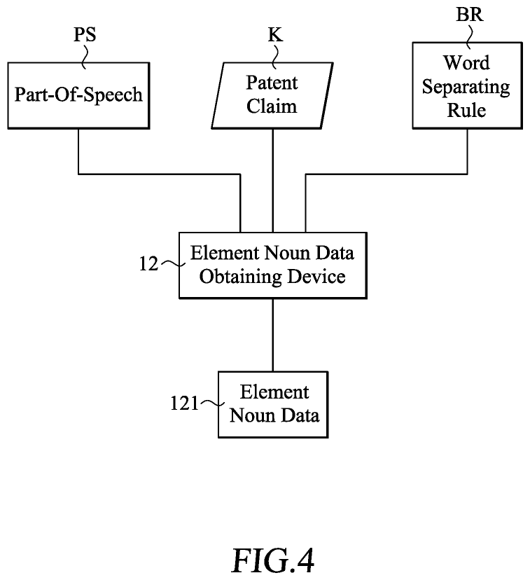

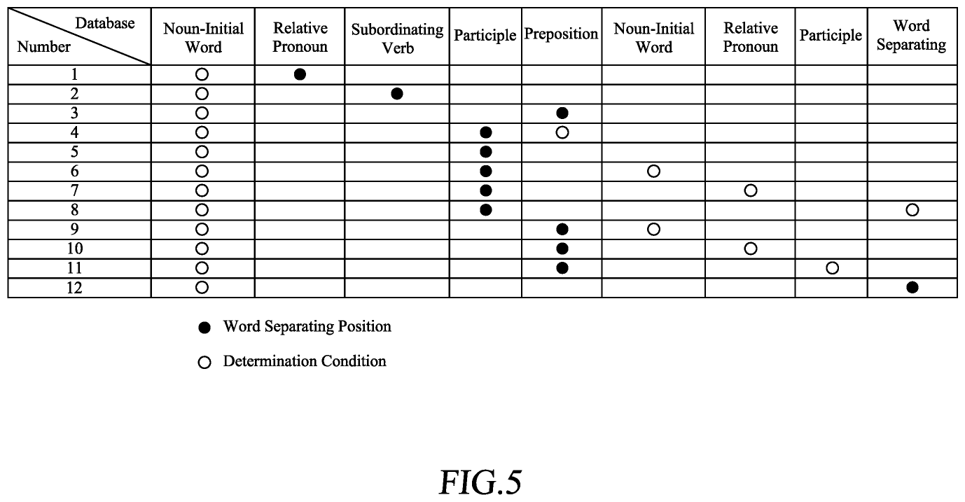

After the paragraph content C of each paragraph S and the paragraph hierarchical level value L of each paragraph content C are obtained, the element noun data obtaining device 12 is operated to obtain the element noun data 121 and the interrelationship data 131 of each paragraph content C. As shown in FIG. 4, the element noun data obtaining device 12, which is connected to the paragraph-content-and-paragraph-hierarchical-level-value determining device 11, is operated to obtain the element noun data 121 from the paragraph content C according to a part-of-speech PS and a word separating rule BR, as shown in FIG. 5.

In the present invention, the element noun data 121 is obtained from each paragraph content C according to a part-of-speech PS and a word separating rule BR, as shown in FIG. 5. The referred embodiment is described as follows.

In the word separating rule BR of the present invention, a plurality of part-of-speech databases are utilized. The word separating rule BR applies the sequential relationship between/among the plurality of word databases, as shown in FIG. 5, to determine an element-noun ending position. The plurality of part-of-speech databases include: a noun-initial word database, a relative pronoun database, a subordinating verb database, a participle database, a preposition database and a sentence separating symbol database.

The noun-initial word database includes: “A”, “a”, “An”, “an”, “The”, “the”, “Said”, “said”, “at least one”, “at least two”, etc.

The relative pronoun database includes: “which”, “whose”, “where”, “wherein”, “where”, etc., the subordinating verb database includes: “is”, “are”, “was”, “were”, etc.

The participle database includes: “the word of ‘provided’ or ending with ‘ed’ or ‘en’ (the collection of the words is adjustable)”, etc.

The participle database includes: “the word of ‘providing’ or ending with ‘ing’ (the collection of the words is adjustable)”, etc.

The preposition database includes “with”, “to”, “in”, “on”, “at”, “over”, “above”, “below”, “along”, “through”, “via”, “within”, “onto”, etc., and

The word separating symbol database includes various punctuations.

In FIG. 5, the words of the claim K are sequentially read. In FIG. 5, when a noun initial word such as “A”, “a”, “The”, “the”, “Said”, “said”, “at least one”, “at least two”, etc. defined in the noun-initial word database is read, the noun initial word is labeled with a mark such as “∘” in FIG. 3 such that the word is taken as a noun initial word, and the reading is continued to determine the element-noun ending position. The present invention applies a mechanism that determines whether a read word is an element-noun-possible-ending word. If it is, the position of the read word is marked with an [symbol] ● [symbol] mark as shown in FIG. 3, and the reading is continued to read an element-noun-possible-ending-confirmation word. If the element-noun-possible-ending-confirmation word is found, which is indicated in FIG. 3 with another “∘” mark in the same row, the element-noun-possible-ending noun will be determined as an element-noun-ending word by which the words from the noun initial word to the element-noun-ending word is the element noun. There are two situations while the element-noun-ending word is determined, including:

Situation (1), a direct determining situation: for example, in the rows numbered 1, 2, 3, and 12 of the word separating rule table, there is not mark “∘” in the right side of the mark “●”, which indicates the element-noun-ending word can be directly determined as word indicated with mark “●” such that the words from the noun-initial to the word prior to the element-noun-ending word represented by “●” is an element noun.

That is, in the rows numbered 1, 2, and 3, after the “noun-initial” is obtained, when the word belonging to any one of the “relative pronoun database”, the “subordinating verb database” and the “preposition database” is obtained, which are all indicated with mark “●” without any mark “∘” followed thereafter, the word is determined as an element-noun-ending word.

Situation (2), an indirect determining situation: in the rows numbered 4-11 of the word separating rule table BR, they are rows having a mark “a” in the right side of the mark “●” in the same row. The mark “●” represents a “possible element-noun-ending position”, which indicates the word position still could not be determined as the “element noun ending position” unless a word represented by “∘” following the “possible element-noun-ending position” is found. For example, in the rows numbered 4-8, after the word of “noun-initial” is obtained and then the reading is continued to read the word belonging to “the participle database” marked with “●”, the present invention has to continuously read the word belonging to databases marked with “∘” including “the participle database”, “the preposition database”, “the noun-initial database”, or “the relative pronoun database”,” to determine that the “possible element-noun-ending position” could be turned to the element-noun-ending position.

For another example, in the rows numbered 9-11, when the word belonging to “the preposition database” is obtained, the position of the word is indicated by “●” and the reading is continued to read. When the word belonging to “the noun-initial database”, “the relative pronoun database”, or “the participle database” is identified as indicated with “∘”, it means that the position of “the preposition database” is turned from “a possible element-noun-ending position” to “an element-noun-ending position.

The follows takes a sentence “a circuit board provided with an edge extending in a longitudinal direction;” as an example to explain how the element noun data is obtained according to the word separating rule in connection to the word database.

(1) First, the word “a” is read from the sentence “[a] circuit board provided with an edge extending in a longitudinal direction;”, which is indicated as the word bracketed by “[ ]”. Because the word of “a” belongs to the “noun-initial database”, the reading is continued for reading the next word;
(2) Next, the word “circuit” is read from “a [circuit] board provided with an edge extending in a longitudinal direction;”, and since the “circuit” does not belong to any word database, the reading is continued for reading the next word;
(3) Next, the word “board” is read from “a circuit [board] provided with an edge extending in a longitudinal direction;”, and since the “board” does not belong to any database, the reading is continued for reading the next word;
(4) Next, the word “provided” is read from “a circuit board [provided] with an edge extending in a longitudinal direction;”, and since the “provided” is identified as belonging to the participle database, therefore according to the word separating rule, the rows numbered 4-8 will be taken into consideration such that the position of “provided” is noted with “●” and is determined as a possible word separating position, and the reading is continued for reading the next word to determine whether the position of “provided” could be further determined as an element-noun-ending position;
(5) Next, the word “with” is read from “a circuit board provided [with] an edge extending in a longitudinal direction;”, and since the “with” is identified as belonging to the preposition database, therefore according to the word separating rule, the row numbered “4” would be taken into consideration in which its column position indicates that it belongs to the preposition database by being noted with “∘”. Therefore, it turns the possible word separating position to be the element-noun-ending position. That is, the “circuit board” prior to the element-noun-ending position is determined as an element noun, and the reading is continued for reading the next word;
(6) Next, the word “an” is read from “a circuit board provided with [an] edge extending in a longitudinal direction;”, and since the “an” is identified as belonging to “the noun-initial database”, the reading is continued for reading the next word;
(7) Next, the word “edge” is read from “a circuit board provided with an [edge] extending in a longitudinal direction;”, and since the “edge” does not belong to any database, the reading is continued for reading the next word;
(8) Next, the word “extending” is read from “a circuit board provided with an edge [extending] in a longitudinal direction;”, and since the “extending” is identified as belonging to the participle database, the position of “extending” is noted with “●” and is determined as a possible word-separating position, and the reading is continued for reading the next word to determine whether the position of “extending” could be further determined as an element-noun-ending position;
(9) Next, the word “in” is read from“a circuit board provided with an edge extending [in] a longitudinal direction;”, and since the “in” is identified as belonging to the preposition database, the row numbered 4 would be taken into consideration in which its column position indicates that it belongs to the preposition database by being noted with “∘”. Therefore, it turns the possible word separating position to be the element-noun-ending position. That is, “an edge”, which is a portion prior to the element-noun-ending position noted with “●”, is determined as an element noun, and the reading is continued for reading the next word;
(10) Next, the word “a” is read from “a circuit board provided with an edge extending in [a] longitudinal direction;”, and since the “a” is identified as belonging to the noun-initial database, the reading is continued for reading the next word;
(11) Next, the word “longitudinal” is read from “a circuit board provided with an edge extending in a [longitudinal] direction;”, and since the “longitudinal” does not belong to any database, the reading is continued for reading the next word;
(12) Next, the word “direction” is read from “a circuit board provided with an edge extending in a longitudinal [direction];”, and since the “direction” does not belong to any database, the reading is continued for reading the next word;
(13) Next, the symbol “;” is read from “a circuit board provided with an edge extending in a longitudinal direction[;]”, and since the symbol “;” is identified as a punctuation mark belonging to the symbol word separating database, the position of “;” is determined as an element-noun-ending position and “a longitudinal direction”, which is a portion prior to the element-noun-ending position noted with “●”, is determined as an element noun.

According to the above, the obtained element nouns are bracketed by IF as follows: “[a circuit board] provided with [an edge] extending in [a longitudinal direction];”.

After the element noun data 121 is obtained, the words connecting between two element noun data 121 will be determined as the interrelationship data 131.

For example, in the aforementioned sentence of “[a circuit board] provided with [an edge] extending in [a longitudinal direction];”, the words between two element nouns are determined as the interrelationship data. Accordingly, the interrelationship data 131 are determined including “provided with”, which is between “an circuit board” and “an edge”, and “extending in” which is between “an edge” and “a longitudinal direction”.

After the element noun data 121 and the interrelationship data 131 are obtained, a division content N of each division T belonging to each paragraph content C is obtained by a division content obtaining device 14 in the present invention. The division content obtaining device 14 is connected to the paragraph-content-and-paragraph-hierarchical-level-value determining device 11, the element noun data obtaining device 12 and the interrelationship data obtaining device 13, and divides each paragraph content C to one or more division contents 141. Each division content 141 includes a division data content 1411 and a division data hierarchical level value 1412 corresponding to the division data content, and the division data content 1411 is a combination of the element noun data 121 and/or the interrelationship data 131.

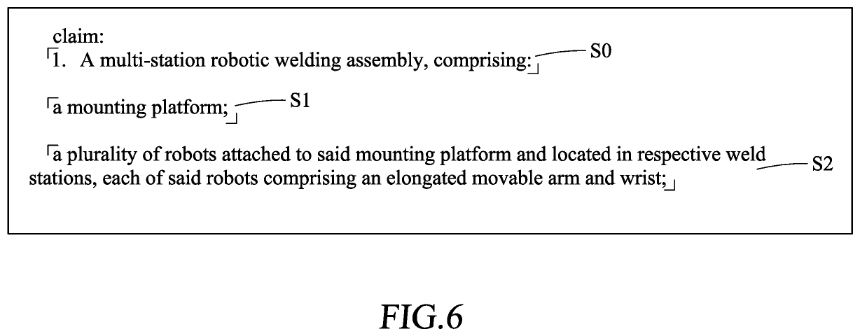

In FIG. 6, for example, there are three paragraphs S provided, including paragraph S0, paragraph S1, and paragraph S2. The paragraph S0 has a paragraph content C0 of “A multi-station robotic welding assembly, comprising:”. The paragraph S1 has a paragraph content C1 of “a mounting platform;”. The paragraph S2 has a paragraph content C2 of “a plurality of robots attached to said mounting platform and located in respective weld stations, each of said robots comprising an elongated movable arm and wrist;”. The following explanation is made by taking the paragraph S2 as an example.

The paragraph content C2 of the paragraph S2 is “a plurality of robots attached to said mounting platform and located in respective weld stations, each of said robots comprising an elongated movable arm and wrist;”. Based on the rules of “enabling the first element noun data to be existed alone”, “enabling one element noun data to be behind one interrelationship data” and “combining some specific interrelationship data such as a subordinating interrelationship, i.e., “comprising” and “and” to the previous element noun data”, the division content obtaining device 14 of the present invention divides the paragraph content C2 to a plurality of divisions T0 (“a plurality of robots”), T1 (“attached to said mounting platform and”), T2 (“located in respective weld stations,”), T3 (“each of said robots comprising”), T4 (“an elongated movable arm and”), and T5 (“wrist;”). Further, each division T is with its division content N. The division content N is defined with a division data content 1411 and a division data hierarchical level value 1412. For example, each division content N0, N1, N2, N3, N4 and N5, which respectively corresponds to divisions T0, T1, T2, T3, T4 and T5, is a combination of the division data content 1411 and the division data hierarchical level value 1412, wherein N0 is defined as {“a plurality of robots”, 0}, N1 is defined as {“attached to”, “said mounting platform”, 1}, N2 is defined as {“and located in”, “respective weld stations,”,1}, N3 is defined as {“each of said robots”, “comprising”, 0}), N4 is defined as {“an elongated movable arm”, 1}), and N5 is defined as {“and”, “wrist;”, 1} in which “a plurality of robots” for N0 is the division data content 1411, and “0” for N0 is the division data hierarchical level value 1412; “attached to” and “said mounting platform” for N1 are the division data content 1411, and “1” for N1 is the division data hierarchical level value 1412; “and located in” and “respective weld stations” for N2 are the division data content 1411, and “1” for N2 is the division data hierarchical level value 1412; “each of said robots” and “comprising” for N3 are the division data content 1411, and “0” for N3 is the division data hierarchical level value 1412; “an elongated movable arm” for N4 is the division data content 1411, and “1” for N4 is the division data hierarchical level value 1412; “and” and “wrist;” for N5 are the division data content 1411, and “1” for N5 is the division data hierarchical level value 1412. The division data content 1411 is the combination of the element noun data 121, obtained by the element noun data obtaining device 12, and the interrelationship data 131, obtained by the interrelationship data obtaining device 13. That is, the obtained result is [symbol] [ {“a plurality of robots”, 0}, {“attached to”, “said mounting platform”, 1}, {“and located in”, “respective weld stations,” 1}, {“each of said robots”, “comprising”, 0}, {“an elongated movable arm”, 1}, {“and”, “wrist,” 1}], 1 [symbol] .

The division data hierarchical level value 1412 is obtained by following rule that “the division data hierarchical level value 1412 is generally increasing by 1 with the level adding of the division hierarchy”. However, for division contents with the subordinating interrelationship data 131 from “comprising” to “and”, or division contents between the “comprising” and “and” (for example, N4 and N5), or division contents of matching interrelationship data (for example, N1 and N2, in which the “and” in N2 is matched with N1), only the division data hierarchical level value 1412 of the first division is increased by 1 but the division data hierarchical level value 1412 of all remaining divisions keeps the same as that of the first division (that is, the division data hierarchical level value 1412 of other divisions is not increased by 1 except the first division). Furthermore, when “wherein” is identified, the division data hierarchical level value 1412 is reset to zero. In conclusion, one paragraph S is dismantled to a plurality of divisions T by the division content obtaining device 14, and each division content N is obtained from each division T according to the positional sequence of each division T. Each division content includes the division data content 1411 and the division data hierarchical level value 1412. After each division T and division content N are obtained, a log file is obtained from a combination of these division content N in sequence and the division hierarchical level value L obtained by the division-content-and-division-hierarchical-level-value determining device 11.

In the present invention, the contents of the paragraph S0, the paragraph S1, the paragraph S2, the paragraph S3, the paragraph S4, and the paragraph S5 are sequentially obtained and are recorded in the log file. However, the present invention is not limited to this, the obtained contents of the paragraph S0, the paragraph S1, the paragraph S2, the paragraph S3, the paragraph S4 and the paragraph S5 may be not recorded in the log file and directly transferred to the structural patent-claim-graphic displaying device 15 such that a structural patent-claim-graphic D is displayed, wherein the structural patent-claim-graphic D has a hierarchical structure and hierarchical position relationship.

As shown in FIG. 1, the structural patent-claim-graphic displaying device 15 is connected to the paragraph-content-and-paragraph-hierarchical-level-value determining device 11 and the division content obtaining device 14. The structural patent-claim-graphic displaying device 15 displays the structural patent-claim-graphic D including the obtained element noun data 121 of the claim K, an element noun hierarchic relationship of the obtained element noun data 121, the obtained interrelationship data 131 and a relationship between/among the obtained element noun data 121 and the obtained interrelationship data 131, wherein the structural patent-claim-graphic D is displayed according to, in each paragraph S, the paragraph hierarchical level value L, a sequential order of the plurality of the division contents T, the division data content 1411 and the division data content hierarchical level value 1412. The structural patent-claim-graphic D has a hierarchical structure and hierarchical position relationship.

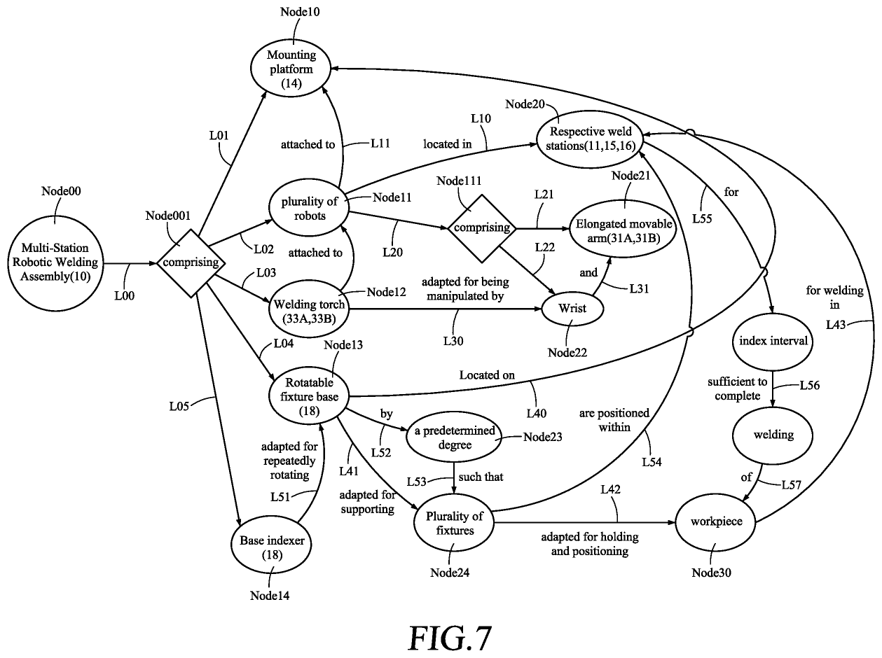

As shown in FIG. 7, in the beginning, a node Node00 is created for the paragraph content of the paragraph S0 ( [symbol] [{“a multi-station robotic welding assembly”, “comprising,”, 0}], 0 [symbol] ). Then, according to the interrelationship data of the subordinating relationship, a node Node001 is created and a connecting line L00 is connected between the node Node00 and the node Node001 in a direction from the node Node00 to the node Node001, i.e., a direction of the connection line is determined by the connection line direction determining device according to a relationship represented by the connection among the interrelationship data and the element noun data to which the connection line is connected.

Next, a determination for the paragraph S1 is operated. The paragraph content of the paragraph S1 is recorded as below.

“ [symbol] [{“a mounting platform;”, 0}], 0] [symbol] ”.

The paragraph hierarchical level value of the paragraph S1 is found as 0, and the paragraph S1 is started with the element noun data having a beginning word “a”. Based on the reason that the beginning word for the paragraph belonging to the subordinating relationship should not be any words of “the”, “said”, or “wherein”, the present invention searches for the nearest previous paragraph having paragraph hierarchical level value equal to the paragraph hierarchical level value of the current paragraph minus 1. After it is found, we determine whether the end of the found paragraph is a subordinating interrelationship data (“comprising”). If all the above conditions are all met, we determine the nearest previous paragraph as a starting point of the subordinating interrelationship data “comprising”, which is the node Node001. Then, the first division data content of “a mounting platform;” is grabbed to create a node Node10 having the first division data content “a mounting platform” to be written. The punctuation “;” in the end of the paragraph S1 indicates the end of the paragraph such that a determination for next paragraph is continued.

Next, the recording of paragraph S2 is performed. The paragraph content of the paragraph S2 is as follows: [symbol] [{“a plurality of robots”, 0}, {“attached to”, “said mounting platform”, 1}, {“and located in”, “respective weld stations,”, 1}, {“each of said robots”, “comprising”, 0}, {“an elongated movable arm”, 1}, {“and”, “wrist,”, 1}], 1 [symbol] .

First, the paragraph hierarchical level value is found as 1, i.e. “1” is located in the end of the paragraph content. In the paragraph content of the paragraph S2, the firstly read division data content, i.e., {“a plurality of robots”, 0}, is with an element noun data “a plurality of robots” starting with a beginning word “a”. In addition, there does not have a paragraph with paragraph content starting with the words of “the”, “said” or “wherein” existing between the paragraph content of the paragraph S2 and its afore-existing subordinating paragraph content such as “comprising”. Thereafter, the present invention searches the nearest afore-existing paragraph having paragraph hierarchical level value equal to the paragraph hierarchical level value of the current paragraph minus 1. Then the present invention checks whether the found paragraph is with a subordination interrelationship data, i.e., “comprising” in the end of the found paragraph or not. If all the above conditions are met, the subordination interrelationship data, i.e., “comprising” in the end of the found paragraph is determined as a starting point, which is the node Node001. The division data content of “a plurality of robots” in the first division content N0 is grabbed to create a node Node11 having the division data content “a plurality of robots”, and a connection line L02 is obtained to connect from the starting point Node001 to the node Node11.

Next, a determination for the second division content N1 {“attached to”, “said mounting platform”, 1} of the paragraph S2 is operated. First, the division hierarchical level value is found as 1, which is found as the division hierarchical level value of the preceding division plus 1 such that it represents the second division N1 is with one degree lower hierarchical level than the preceding division NO. Then, the preceding division N0 is taken as a starting point of the connection line to the second division N1. Thereafter the present invention determines whether the element noun data in the division data content N1 has already defined. Since the element noun data “said mounting platform” has been defined in the node Node10, the present invention determines that a connection line L11 is with a direction from the node Node11 to the node Node10. In addition, the interrelationship 131 of the division data content, i.e., “attached to”, is attached on the connection line L11. A first color is used to mark the connection line L11, and the connection line L11 is with direction arrow from the node Node11 to the node Node10 as shown in FIG. 7.

Next, a determination for the third division content, i.e., {“and located in”, “respective weld stations,”, 1}, of the paragraph S2 is operated. First, the division hierarchical level value is found as 1, which is found as the same as the division hierarchical level value of the preceding division. Then, the present invention determines there is a matching relationship between the third division and the preceding paragraph such that the element noun data of the preceding division is not taken as the starting point, and the nearest division having division hierarchical level value which is the same as the division hierarchical level value of the current division minus 1 is taken as the starting point. Thereafter, the present invention searches for the node of element noun data of the division having division hierarchical level value equal to zero as a starting point, which is the node Node11, and the present invention determines whether the element noun data, which is “respective weld stations”, of the division data content N1 has already defined before. If the present invention determines the element noun data of the division data content does not exist, a node Node20 of the element noun data is created and a connection line L10 is obtained to connect from the starting point Node11 to the node Node20. The first color is used to mark the connection line L10, and the connection line L10 is with direction arrow from the node Node11 to the node Node20.

Next, a determination for the fourth division content, i.e., {“each of said robots”, “comprising”, 0}, of the paragraph S2 is operated. First, in the reading of the division data content “each of said robots”, “said robots” is read such that it represents “robot” has appeared in the preceding content. Therefore, the node Node11 is obtained by searching the node of “robot”. The division data of the following division, which is “comprising”, is obtained by taking the node Node11 as the starting point of a connection line L20. Due to the particularity of “comprising”, a node Node111 of the “comprising” is created and the connection line L20 is obtained to connect from the starting point Node11 to the node Node111 with marked direction and color.

Next, a determination for the fifth division content, i.e., {“an elongated movable arm”, 1}, of the paragraph S2 is operated. First, the paragraph hierarchical level value is found as 1, and the element noun data thereof is found with a beginning word “a”. In addition, there does not have a division, having division content starting with the words of “the”, “said”, or “wherein”, existing between the division content of the fifth division and its afore-existing subordinating division content, i.e., “comprising”. Thereafter, the present invention searches for the nearest afore-existing division having division hierarchical level value equal to the division hierarchical level value of the current paragraph minus 1, and therefore the fourth division is found. Then, the present invention determines whether the found division, i.e., the four division, is with a subordinating interrelationship data, i.e., “comprising” in the end of the found division or not. It is found all the above conditions are met. Therefore, the subordinating interrelationship data, i.e., “comprising” in the end of the found division is determined as a starting point, which is a node Node111. Then, the first division data content “an elongated movable arm” is grabbed to create a node Node21 having the first division data content “an elongated movable arm”. A connection line L21 is obtained to connect from the starting point Node111 to the node Node21. Thereafter the determination continues.

Next, a determination for the sixth division content, i.e., [symbol] {“and”, “wrist,”, 1}], 1 [symbol] , of the paragraph S2 is operated. First, the paragraph hierarchical level value is found as 1, and the sixth division content is started with the element noun data with a beginning word “and” followed by a word other than “the”, or “said”. In addition, there does not have a division, having division content starting with the words of “the”, “said”, or “wherein”, existing between the division content of the sixth division and its afore-existing subordinating division content, i.e., “comprising”. Thereafter, the present invention searches for the nearest afore-existing division having division hierarchical level value equal to the division hierarchical level value of the current division minus 1 (the fifth division). Then, the present invention determines whether the found division is with a subordinating interrelationship data, i.e., “comprising” in the end of the found division or not. It is found that all the above conditions are met. Therefore, the subordinating interrelationship data. i.e., “comprising” in the end of the found division is determined as a starting point, which is the node Node111. Then, the division data not including the word of “and” is grabbed to create the node Node22 having the division data content “wrist”. A connection line L22 is obtained to connect from the starting point Node 111 to the node Node22, and the semicolon (“;”) behind “wrist” is obtained so as to determine that the reading of the paragraph is ended and a determination for the new paragraph is operated.

According to the above method, the structural patent-claim-graphic D in FIG. 7 is obtained, and the structural patent-claim-graphic D has a hierarchical structure and hierarchical position relationship.

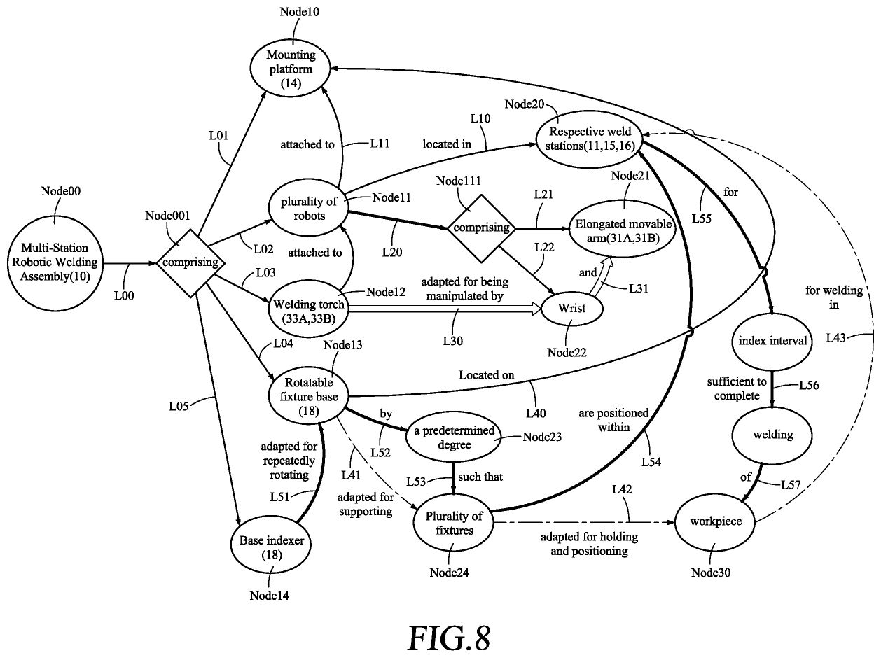

As shown in FIG. 1 and FIG. 8, according to the embodiment of the present invention, the structural graphic patent claim displaying equipment 1 further includes a connection line color determining device 16 which determines a color of a connection line of each paragraph S according to coherent characteristics and adjacent characteristics of the interrelationship data in all paragraphs S. As shown in FIG. 8, according to coherent characteristics of the interrelationship data, for example, a connection line L30 and a connection line L31 are displayed by the same color, such as a first color. A connection line L51, a connection line L52, a connection line L53, a connection line L54, a connection L55, a connection L56, and a connection L57 are displayed by the same color, such as a second color. A connection L41, a connection line L42, and a connection line L43 are displayed by the same color, such as a third color. The first color, the second color, and the third color are three different kinds of colors and are colors of different color systems. For example, the first color, the second color, and the third color cannot be the light blue, the medium blue, and the dark blue respectively since they belong to the same color system. Different connection lines can be distinguished by marking with different kinds of colors of different color systems in color system table. However, in a criterion, the connection lines having the same starting position (for example, the connection lines L10, L11, L20 from the node Node11) and the subsequent connection lines are displayed with different colors (but the same coherent connection lines are displayed with the same color), or the connection lines having the same starting point and/or middle point (for example, the node Node13 is the starting point of the connection line L40 and is also the middle point between the connection line L51 and the connection line L41) are displayed with different colors. That is, the connection line L51, the connection line L52, the connection line L53, the connection line L54, the connection line L55, the connection line L56 and the connection line L57 are displayed with one color, and the connection line L41 and the connection line L42 are displayed with another color. In one embodiment, a special processing is applied on a single node having a plurality of incoming connection lines and a plurality of branching connection lines to avoid the condition that the incoming connection line and the branching connection line cannot be distinguished. For example, a node Node24 has two incoming connection lines (the connection line L41 and the connection line L53) and two branching connection lines (the connection line L42 and the connection line L54), and the two routes of the node are marked with different colors.

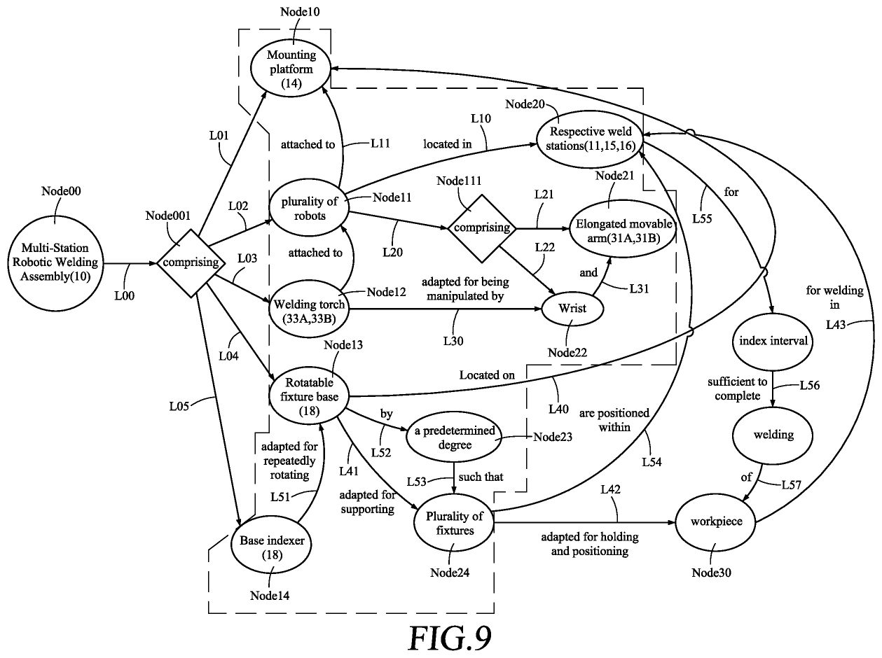

As shown in FIG. 1 and FIG. 9, according to the embodiment of the present invention, the structural graphic patent claim displaying equipment 1 further comprises a hierarchical level input device 17 being connected to the structural patent-claim-graphic displaying device 15. The hierarchical level input device 17 has a hierarchical level input interface 171 (i.e. input a hierarchical level value on the screen). The hierarchical level input interface 171 is provided, after a user inputs a hierarchical level number, for example, 2, to designate a hierarchical range of the structural graphic patent claim displayed by the structural patent-claim-graphic displaying device 15 (for example, displaying two hierarchical levels), and therefore the nodes Node00 (the first hierarchical level), Node10, Node11, Node12, Node13 and Node14 (the second hierarchical level), and the interrelationship between these nodes are displayed, as indicated by the coverage of the dotted lines.

In one embodiment, as shown in FIG. 1 and FIG. 9, the hierarchical level input interface 171 is provided, after a user inputs a hierarchical range, for example, the second to the third, to display a graphic within the designated hierarchical range, which displays the nodes Node10, Node11, Node12, Node13, Node14 (the second hierarchical level), Node20, Node21, Node22, Node23, Node24 (the third hierarchical level), Node111 (the node between the second hierarchical level and the third hierarchical level), and the connection lines among these nodes, as indicated by the coverage of the dotted lines.

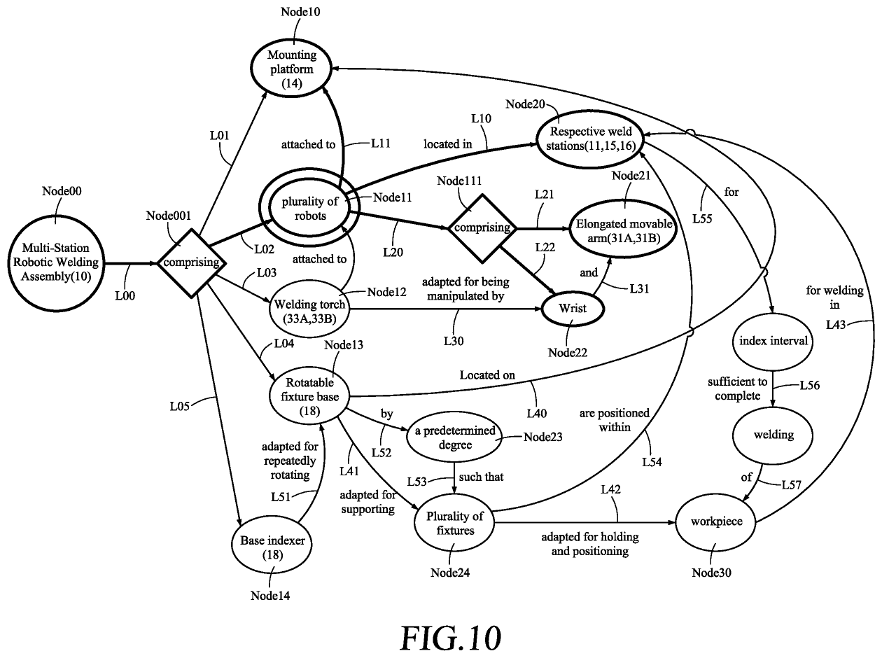

As shown in FIG. 1 and FIG. 10, according to one embodiment of the present invention, the structural patent-claim-graphic automatic displaying equipment 1 further comprises a division data content determining device 18 being connected to the structural patent-claim-graphic displaying device 15. The division data content determining device 18 has a division data content determining interface 181 which allows a user to designate a designated element noun data and/or a designated interrelationship of the structural graphic patent claim so as to display all of route data connected between/among the designated element noun data and/or the designated interrelationship data. The route data includes the element noun data and/or the interrelationship data which are/is connected to the designated element noun data and/or the designated interrelationship data.

For example, after a user clicks on a designated element noun data, which is displayed at a node such as the node Node11 on the division data content determining interface 181, the present invention will display all of routes connected to the node Node11, including the nodes Node00, Node001, Node11, Node10, Node20, Node111, Node21, and Node22, and the interrelationship (the connection line L00, the connection line L02, the connection line L10, the connection line L11, the connection line L20, the connection line L21, and the connection line L22). Alternatively, after a user clicks on a designated interrelationship data, for example, the connection line L10, the present invention displays all of nodes (Node00, Node001, Node11, and Node20) connected to the interrelationship (the connection line L10) and the interrelationship (the connection line L00, the connection line L02, and the connection line L10).

The above description should be considered only as an explanation of the preferred embodiment of the present invention. A person with ordinary skill in the art can make various modifications to the present invention based on the scope of the claims and the above description. However, those modifications shall fall within the scope of the present invention.

What is claimed is:

1. A structural patent-claim-graphic automatic displaying equipment that automatically transfers a patent claim to a structural patent-claim-graphic and displays the structural patent-claim-graphic, the structural patent-claim-graphic automatic displaying equipment comprising:
a paragraph-content-and-paragraph-hierarchical-level-value determining device, which determines, for all paragraphs in the patent claim, a paragraph content and a paragraph hierarchical level value corresponding to the paragraph;
an element noun data obtaining device being connected to the paragraph-content-and-paragraph-hierarchical-level-value determining device, the element noun data obtaining device obtaining all element noun data from each paragraph content according to a part-of-speech of paragraph content words and a word separating rule;
an interrelationship data obtaining device being connected to the paragraph content-and-paragraph-hierarchical-level-value determining device and the element noun data obtaining device, the interrelationship data obtaining device obtaining, from each paragraph content, interrelationship data which corresponds to the obtained element noun data;
a division content obtaining device being connected to the paragraph-content and-paragraph-hierarchical-level-value determining device, the element noun data obtaining device and the interrelationship data obtaining device, wherein the division content obtaining device divides each paragraph content to one or more division contents, each division content includes a division data content and a division data hierarchical level value corresponding to the division data content, and the division data content is a combination of the element noun data and/or the interrelationship data; and
a structural patent-claim-graphic displaying device being connected to the paragraph-content-and-paragraph-hierarchical-level-value determining device and the division content obtaining device, wherein the structural patent-claim-graphic displaying device displays the structural patent-claim-graphic including the obtained element noun data, an element noun hierarchic relationship of the obtained element noun data, the obtained interrelationship data and a relationship between/among the obtained element noun data and the obtained interrelationship data in such a manner that the structural patent-claim-graphic is displayed according to, in each paragraph, the paragraph hierarchical level value, a sequential order of the plurality of the division contents, the division data content and the division data content hierarchical level value, and the structural patent-claim-graphic has a hierarchical structure and hierarchical position relationship.

2. The structural patent-claim-graphic automatic displaying equipment as claimed in claim 1, wherein the structural patent-claim-graphic is displayed by determining whether the division data content is a subordinating interrelationship word and/or is a punctuation mark.

3. The structural patent-claim-graphic automatic displaying equipment as claimed in claim 1, wherein the structural patent-claim-graphic is displayed by determining a subordinating relationship between/among the plurality of element noun data of the division data content.

4. The structural patent-claim-graphic automatic displaying equipment as claimed in claim 1, wherein the element noun data is displayed at a node, and the interrelationship data is displayed as a connecting line connected between a plurality of the nodes.

5. The structural patent-claim-graphic automatic displaying equipment as claimed in claim 1, wherein the division content obtaining device enables one or more of the obtained division contents to be recorded in a log file, and the log file is transferred to the structural patent-claim-graphic displaying device such that the structural patent-claim-graphic displaying device displays the structural patent-claim-graphic according to the log file.

6. The structural patent-claim-graphic automatic displaying equipment as claimed in claim 5, wherein the log file is recorded according to a positional sequence of the element noun data and the interrelationship data in each paragraph.

7. The structural patent-claim-graphic automatic displaying equipment as claimed in claim 6, further comprising a connection line color determining device, the connection line color determining device being provided to determine a color of a connection line of each paragraph according to coherent characteristics and adjacent characteristics of the interrelationship data in each paragraph, in which the connecting line being provided to represent the interrelationship data.

8. The structural patent-claim-graphic automatic displaying equipment as claimed in claim 7, further comprising a connection line direction determining device, the connection line direction determining device determining a direction of the connection line according to a relationship among the interrelationship data and the two element noun data to which the connection line is connected.

9. The structural patent-claim-graphic automatic displaying equipment as claimed in claim 1, further comprising a hierarchical level input device, the hierarchical level input device being connected to the structural patent-claim-graphic displaying device, the hierarchical level input device having a hierarchical level input interface, the hierarchical level input interface being provided, after a user inputs a hierarchical level number, to designate a hierarchical range of the structural patent-claim-graphic displayed by the structural patent-claim-graphic displaying device.

10. The structural patent-claim-graphic automatic displaying equipment as claimed in claim 8, further comprising a division data content determining device, the division data content determining device being connected to the structural patent-claim-graphic displaying device, the division data content determining device having a division data content determining interface which allows a user to designate a designated element noun data and/or a designated interrelationship of the structural patent-claim-graphic so as to display all of route data connected between/among the designated element noun data and/or the designated interrelationship data, wherein the route data includes the element noun data and/or the interrelationship data which are/is connected to the designated element noun data and/or the designated interrelationship data.
